(19) United States
(12) Patent Application Publication
(10) Pub. No.: US 2005/0133596 A1
(43) Pub. Date: Jun. 23, 2005

(54) Portable electronic voting device, improved ballot and improved voting method

(76) Inventors: Antonio Mugica, Boca Raton, FL (US); Paul Babic, Caracas (VE); Eduardo Correia, Caracas (VE)

Correspondence Address: JEFFREY FURR, 253 N. MAIN STREET, JOHNSTOWN, OH, 43031, US

(21) Appl. No.: 10/707,545

(22) Filed: Dec. 19, 2003

(51) Int. Cl. G06F 17/60

(52) U.S. Cl. 235/386

(57) ABSTRACT

On the preferred embodiment, this invention comprises a pen-like bar code scanning device used by an individual voter during an election to scan the names of his or her preferred candidates off a single preprinted improved ballot sheet. The candidate-related data read by the scanner is submitted to a voting machine in a standard protocol, which may allow vote verification and casting in an electronic fashion. The ballot paper remains intact and, hence, it can be used by all voters assigned to a specific voting device, machine or precinct. The main function and object of this device is to facilitate voter's introduction of voting choices using inexpensive prior art technology while eliminating the need to preprint millions of ballots for an election process.

### BACKGROUND OF INVENTION

1. Field of Invention

This invention relates to a device, improved ballot and improved method to register an individual's vote during any type of election and referendum processes.

2. Discussion of Prior Art

The prior art contains hundreds of examples of different voting systems, both mechanical and electronic. Slowly, voting systems have been evolving to simplify the process of voting, increase security, and reduce the costs and complexity inherent to an election process. Over time, mechanical voting systems have been almost completely substituted by electronic voting systems of different fashions.

In the prior art, there are several modes in which a voter can enter his or her election choice into an electronic voting machine, the most common fashion still relying on a voter entering vote selections on a paper ballot through manual marking, and then scanning the marked ballot to digitize the cast votes and optimize the totalization and outputting process (e.g., Narey, U.S. Pat. No. 4,813,708). The disadvantages of these voting methods and systems has been thoroughly discussed in the prior art.

Further approaches have eliminated the need to print millions of paper ballots by introducing purpose-specific, vote-casting machines (e.g., Boram, U.S. Pat. No. 4,461,240) that can be election-customized by affixing a ballot overlay over it containing candidate and election data for a specific voting process and precinct. One of the main drawbacks of this approach is the fact that generally custom devices need to be produced, which process may result in undesirably high costs, especially for elections in which several dozens of candidates are vying for a single office. Moreover, the cost of building and maintaining custom devices is generally higher when compared to deploying and maintaining commercial, off-the-shelf devices, such as bar code scanners.

### SUMMARY OF INVENTION

### OBJECTS AND ADVANTAGES OF THE INVENTION

The main object of the disclosed voting device, ballot and voting method is to provide an alternative to prior art that further reduces costs and logistics complexity associated with elections processes.

Accordingly, several objects of the invention are:
To provide a voting device that leverages off-the-shelf technology, thus eliminating the need for more expensive, custom-made designs, and permitting easier maintenance and replacement;
To provide a voting method in which a voting device is used sequentially by multiple voters in a voting precinct conjunction with a single improved ballot, thus eliminating the need to print ballots for every voter;
To provide a voting device that can be used in conjunction with existing electronic voting machines;
To provide a voting device that is relatively simple to set up for any particular elections.

### SUMMARY OF THE INVENTION

To overcome the disadvantages of the prior art, an improved voting device can be used in conjunction with an improved ballot and method of voters making voting choices. The improved voting device may consist of existing off-the-shelf products and therefore it can significantly reduce the total cost of an elections process by reducing the cost of the voting systems deployed to voting precincts. The disclosed voting device is used in conjunction with an improved ballot, which only requires that a single ballot be printed for every precinct and ballot style possible, thus eliminating the need to produce one ballot for every voter and reducing the cost and complexity of the logistics associated with an elections process.

The disclosed voting device is meant for use as an attachment to a prior art electronic voting machine, which hosts the voting device and which may potentially be any suitable electronic voting machine (and totalization system) in the prior art (such as the AES-3000 model produced by Smartmatic). The voting device has optical scanning capabilities, such as found in a bar code or other type of prior art optical reader. In addition, the voting device is of a handheld nature, so that a voter can hold it in his or her hands to perform the voting act.

The proposed improved voting method is as follows:
The voter is led to the enclosure where the voting act is to be performed.
The voter is handed the disclosed voting device, as well as the improved ballot of the present invention, which is to be used during the voting act (details of the improved ballot are discussed below).
The voter uses the handheld voting device to scan the improved ballot, scanning those areas of the improved ballot that correspond to the voting choices that the voter wishes to make. This causes the voting device to read optical data off the improved ballot and transmit it to the electronic machine hosting the voting device. The characteristics of the optical data scanned by the voting device are described below.
Once voting data have been transmitted to the electronic voting machine, the voting process continues as required by the selected prior art electronic voting machine.

As is common in election processes, there may be different ballot styles within a single elections process. Each of these ballot styles, as known in prior art, comprises elections data that may pertain to one or more specific voting precincts, such as candidates, offices for which said candidates vie, and legal restrictions on voting for said offices (in case of national elections), or such as questions and allowed valid answers for every question (in case of referenda).

According to the present invention, every possible voting choice that can be performed by voters is associated with a unique identifier throughout the entire voting process. Such identifier uniquely identifies every possible voting choice so that no two voting choices can have the same identifier, whether in the same or different ballots or ballot styles. Improved ballots may thus be created by printing (or otherwise making visible) the elections data onto paper or any other more wear-and-tear resistant material, as desirable. When election data are printed to create improved ballots, every voting choice (whether an election candidate/office option or referendum question/answer option) is printed alongside its established unique identifier in a way as to enable a voter to clearly understand that a relationship exists between every voting choice and its associated identifier. At the same time, in addition to the unique identifiers being visible to the voter, unique identifiers must be printed in a way as to be readable to the voting device using the scanning technology supported by the voting device.

During the voting process, thus, for every voting choice the voter wishes to make, he or she can make said choices by scanning the printed unique identifiers found on the improved ballots, which correspond to the candidates or answers he or she wishes to select or introduce. Once voting choices are made, voting data is transmitted by the voting device onto the prior art electronic voting machine in use so that the voting process can continue as required by said machine.

There are two noteworthy aspects to this:
As the voter need not make any markings on the improved ballot, the same ballot can be used by several voters. If the improved ballot is to be printed in such material as cannot be in any way damaged by common use and handling by voters, one single ballot may be used to carry out an entire elections process within a voting precinct. This means that there need by at the most as many improved ballots as there are precincts, not as many ballots as there are voters.
Additional unique identifiers may be printed onto the improved ballot, which could cause transmission of command data to the electronic voting machine. For instance, scanning a specific unique identifier associated with a label reading “Cast Vote” could trigger the electronic voting machine to complete the vote casting process; scanning another unique identifier associated with a label reading “Start Over” could have the electronic voting machine to erase partial voting data introduced by a specific voter before casting his or her vote, so that he or she can start introducing his or her voting choices from scratch once again (e.g., in case the wrong voting choice was introduced by mistake).

### BRIEF DESCRIPTION OF DRAWINGS

This invention will be better understood if reference is made in the accompanying drawings in which:

FIG. 1 shows an overview of the disclosed voting device and improved ballot as would be used within a complete voting system

FIG. 2 shows a more detailed view of the improved ballot for the case of national elections

FIG. 3 shows a more detailed view of the preferred embodiment of the handheld voting device in use with the improved ballot

FIG. 4 shows a flow diagram of the voting process using the disclosed voting method

### LIST OF REFERENCE NUMERALS

10 Prior art electronic voting machine

20—Connection cable (cable that interconnects voting device and electronic voting machine)

30—Voting device (preferred embodiment)

40—Improved ballot (preferred embodiment)

50—Election choices (preferred embodiment)

60—Election data associated with election choice (preferred embodiment)

70—Unique identifier associated with election choice (preferred embodiment)

90—Scanning sensor (component of voting device)

100—Device body (component of voting device) 1

120—Activation button (optional component of voting device)

200, 210, 220, 230—Sequential steps involved in the proposed voting method

### DETAILED DESCRIPTION

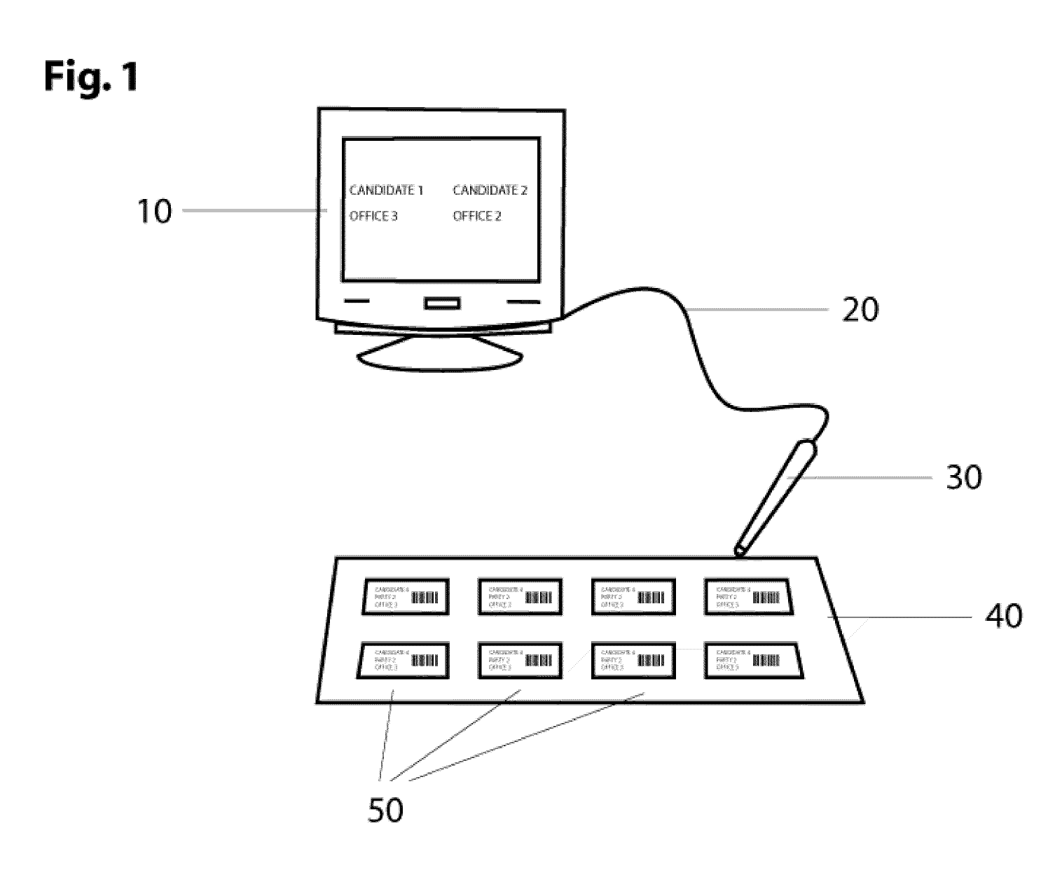

FIG. 1 shows the equipment used by voters at the voting precinct as described in this invention. Note that the electronic voting machine 10 (EVM) may be any suitable electronic voting machine in the prior art to which the voting device 30 (VD) of this invention can be connected, such as the AES-3000 produced by Smartmatic Corporation. Improved ballot 40 (IB) has been generated (printed) so as to comprise election choices 50, each election choice 50 being a complete and valid voting choice comprising both election data 60 for a specific candidate for a specific office and the unique identifiers 70 corresponding to each choice as described above.

Each improved ballot 40 contains as many voting choices as required for a specific election process. In one preferred embodiment, the improved ballot is printed on regular paper using color laser jet printing technology as known to someone skilled in the art. In another preferred embodiment, the improved ballot is fixed on a more resistant material such as polycarbonate (e.g., “lexan”) using a suitable industrial printing process known to one skilled in the art. In both cases the unique identifier 70 associated with each election choice 50 is printed using the same technology as used to print election data 60 to minimize ballot production costs.

The voting device 30 is connected to the prior art EVM 10 using a standard communication media and protocol, wired or wireless. In the preferred embodiment, the voting device 30 is connected to the EVM 10 using standard serial communications means and protocol RS-232. The type of cable used to connect voting device 30 to the EVM 10 depends on the connectors found on the EVM 10 side of the connection. In the preferred embodiment the voting device 30 and EVM 10 are connected by a level-5 UTP wire using a DB-9 connector on the EVM extreme. On the voting device's side the connection is of a permanent fashion.

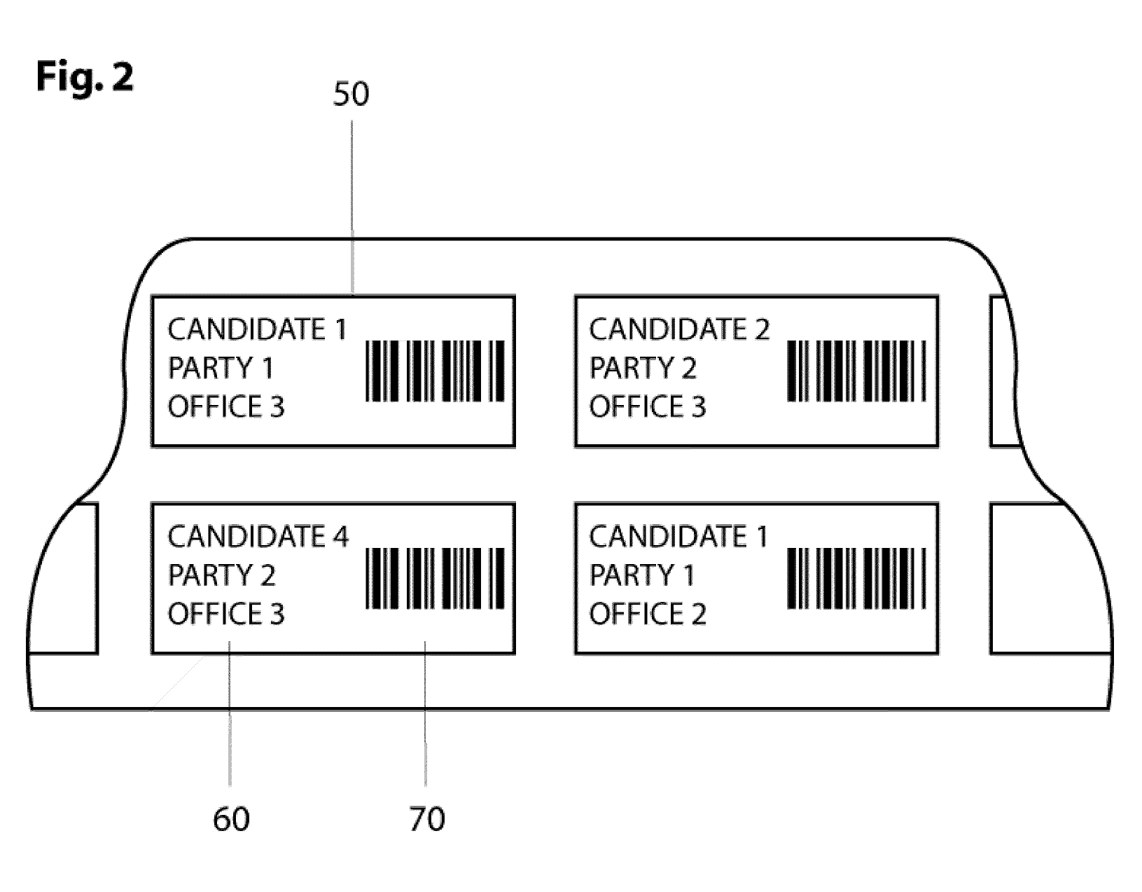

FIG. 2 shows a close-up of the improved ballot for an exemplary national elections ballot. Every election choice 50 comprises two parts, namely, election data 60 and unique identifier 70. Each election data 60 presents information on a specific candidate and office to the voter. Also, associated with each election data 60 is a unique identifier 70, such that when the voter scans a specific unique identifier, the corresponding election data may be transmitted by the voting device 30 to the EVM 10 for vote casting and totalization. In the preferred embodiment, the unique identifier can be printed on the improved ballot 40 in the form of a conventional bar code as known in the prior art (an alternative fashion to fix the unique identifiers 70 on the improved ballot 40 would be to use a standard two-dimensional symbology, such as PDF417; however, bar code remains the optimal choice because of the relative inexpensiveness of bar code scanners). As mentioned above, the improved ballot 40 can have additional unique identifiers, which may cause transmission of command data to the electronic voting machine. For instance, scanning a specific unique identifier 70 associated with a label reading “Cast Vote” could trigger the electronic voting machine to complete the vote casting process. Several other command possibilities should be evident to someone skilled in the art.

When a voter wishes to add a specific election choice 50 to his or her cast vote, he or she must present the voting device 30 at the unique identifier 70 of choice. The exact mode of operation shall depend on the specific technology used to position the unique identifiers 70 on the improved ballot, and on the fashion of the handheld scanning device used to implement the voting device 30. For instance, if bar coding is used, the voting device 30 must be slid across the bar code; if two-dimensional symbology is used, the voting device need be set near the symbol so that the data is read. The required mode of operation of the voting device 30 is evident to one skilled in the art.

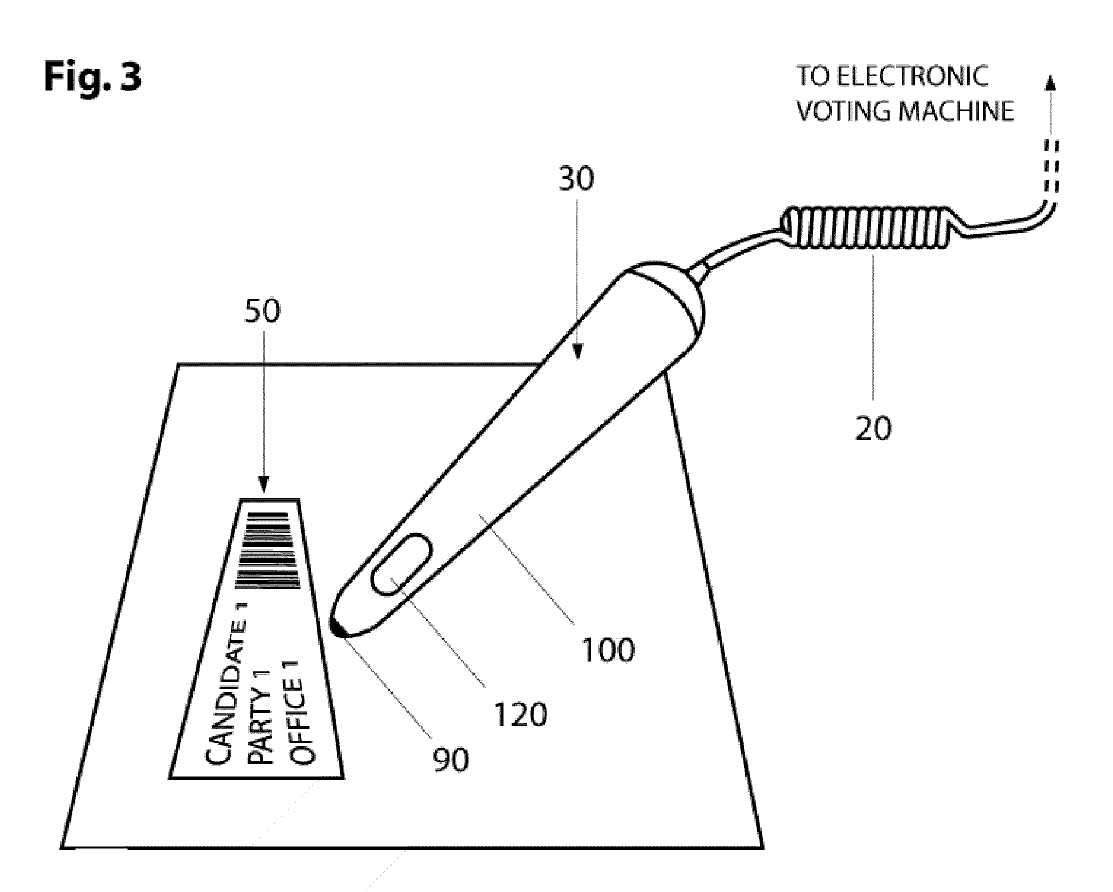

FIG. 3 shows a close-up look at the voting device 30 as used to scan election choices 50 found in improved ballots 40. Voting device 30 comprises four special purpose components, namely, a scanning sensor 90, a device body 100, a connection cable 20, and an activation button 120. In the preferred embodiment, the voting device 30 comprises a device body 100 having the form factor of a handheld electronic pen, such as those commonly found in public library check-out counters. Other form factors are possible, but the pen form factor is preferred because everybody knows how to hold and use a pen.

Voting device 30 has a serial connector cable 20 on the top extreme that allows connection of the VM 30 to the electronic voting machine 10 of choice. As described above, connection cable 20 is a level-5 UTP cable using a DB-9 connector on the extreme leading to the EVM 10. In the preferred pen-like embodiment, the scanning sensor 90 is located at the tip of the voting device 30 so as to encourage the natural use of a pen to make election choices. The activation button 120 is an optional feature that may be used to activate and deactivate the scanning mechanism of the voting device 30 to prevent accidental scanning. In the preferred embodiment, the button must be depressed to activate the scanning mechanism; the same is deactivated as soon as the activation button 120 is released.

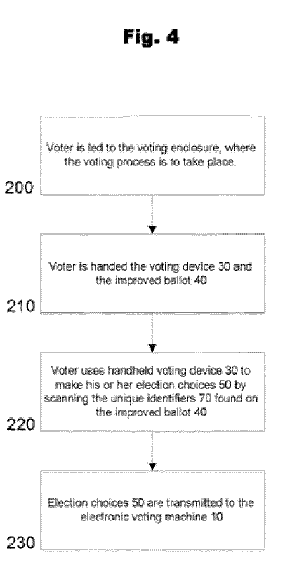

FIG. 4 shows the most basic flow diagram of the present invention, describing how a vote is cast using the voting device. In addition to the shown steps, as mentioned above, the improved ballot can optionally comprise additional steps unique identifiers 70 which could be used by the voter to cast the vote, erase his or her current selection, among many other options that are evident to one skilled in the art.

Conclusion, Ramifications and Scope of Invention

The disclosed voting device, improved ballot and voting method, including the corresponding preferred embodiments, were described in the context of national elections because such election processes are the most evident uses of the voting device, improved ballot and voting method. However, additional embodiments should be evident to one skilled in the art. For instance, the described improved ballot 40 shown in FIG. 2 illustrates an exemplary national elections ballot. An improved ballot could likewise be designed and printed when the elections process is of a referendum nature.

In addition, as described above, the electronic voting machine 10 may be of any type provided a suitable communication channel (both in terms of physical connection and logical communications) can be established between the voting device 30 and the electronic voting machine 10. As the preferred embodiment of the voting device 30 comprises a serial communications link with the EVM 10, there should be no problem for someone skilled in the art to connect said voting device 30 to a standard electronic voting machine based on a PC architecture, provided a suitable off-the-shelf product is chosen to implement the voting device 30.

In an additional embodiment of the invention, the voting device 30 could have the capability to preprocess the elections data scanned of the improved ballots, so as to insert additional information that can increase security of the elections process. For instance, information about how many election choices have been made using a specific voting device could be transmitted to help auditing. Elections data could also be preprocessed by the voting pen 30 to encrypt it before transmitting it to the EVM 10.

While our above description contains many details, these should not be construed as limitations to the scope of the invention, but rather as an exemplification of one or more preferred embodiments thereof. Obviously, modifications and alterations will occur to others upon a reading and understanding of this specification. The description above is intended, however, to include all such modifications and alterations insofar as they come within the scope of the appended claims or the equivalents thereof.

1. A ballot made for use in facilitating an election, the ballot comprising:
at least one surface in which election choices have been recorded and made visible in a permanent fashion;
said election choices are provided to voters for election purposes, and each election choice comprising both election data and a unique identifier; and
each said election choice additionally comprising said unique identifier, said identifier being a code that uniquely identifies said election choice, and which is printed on said ballot in a form as to be readable using an optical scanning means.

2. The ballot of claim 1, which said election data includes candidate and office.

3. The ballot of claim 1, which said election data includes questions and answer information as required for the election process.

4. The ballot of claim 1, which said identifier is one-dimensional.

5. The ballot of claim 1, which said identifier is two-dimensional.

6. The ballot of claim 1, in which said election choices are printed on said ballot in a way as to enable a voter to clearly understand that a relationship exists between each said election data comprised in an election choice and each said unique identifier associated with the same election choice.

7. The ballot of claim 2, in which said ballot is made of a wear-and-tear-resistant material.

8. The ballot of claim 2, in which said ballot is made of paper.

9. An electronic voting device voting device comprising:
a chassis;
an optical scanning means for reading unique identifiers printed on a ballot, said ballot having election choices with each election choice comprising both election data and a unique identifier;
a communication means;
a data transmission means for transmitting each said unique identifiers read through said optical scanning means off said ballot using said communications means to an external system.

10. The electronic voting device of claim 9 in which said communication means is done by a wireless communications.

11. The electronic voting device of claim 9 in which said chassis is designed to allow a voter to vote by holding and using said device in his or her hand.

12. The electronic voting device of claim 9 in which said external system is an electronic voting system with communication means suitable for establishing a communications channel between said device.

13. The electronic voting device of claim 9 in which said device can has an activation button.

14. The electronic voting device of claim 13 in which said activation button is used by the voter to activate said device's optical scanning means whenever said voter wishes to scan said ballot.

15. The method of claim 9 in which said election choice of said voter's preference is transmitted to an external system for vote totalization purposes.

16. A method of casting votes comprising the steps of:
having a voter being led to a voting enclosure where the voting process is to take place;
having said voter being handed both a electronic voting device and a ballot;
having said electronic voting device being comprised of a chassis, an optical scanning means for reading unique identifiers printed on a ballot, said ballot having election choices with each election choice comprising both election data and a unique identifier;
a communication means, and a data transmission means for transmitting each said unique identifiers read through said optical scanning means off said ballot using said communications means to an external system;
having said ballot comprising at least one surface in which election choices have been recorded and made visible in a permanent fashion, said election choices are provided to voters for election purposes, and each election choice comprising both election data and a unique identifier, and each said election choice additionally comprising said unique identifier, said identifier being a code that uniquely identifies said election choice, and which is printed on said ballot in a form as to be readable using an optical scanning means;
having said voter using said device to scan the election choices found on said ballot by scanning the unique identifiers associated with the election choice of his or her preference; and
having said election choice of said voter's preference being transmitted to an external system by said device.

17. The method of claim 16 in which said election choice of said voter's preference is transmitted to an external system for vote totalization purposes.

18. The method of claim 16 in which said communication means is done by a wireless communications.

19. The method of claim 16 in which said chassis is designed to allow a voter to vote by holding and using said device in his or her hand.

20. The method of claim 16 in which said chassis has an activation button is used by the voter to activate said device's optical scanning means whenever said voter wishes to scan said ballot.
